(19) United States
(12) Patent Application Publication
(10) Pub. No.: US 2005/0073928 A1
(43) Pub. Date: Apr. 7, 2005

(54) [OPTICAL MEDIUM STORAGE READING DEVICE]

(76) Inventors: Her-Shang Chen, Taichung City (TW); Chih-Wen Huang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,918

(22) Filed: Nov. 6, 2003

(30) Foreign Application Priority Data
Oct. 3, 2003 (TW) 92127383

(51) Int. Cl. G11B 7/00

(52) U.S. Cl. 369/53.26; 369/121; 369/53.28; 369/53.2

(57) ABSTRACT

An optical storage medium reading device comprising an optical storage module, a light-switching module, a wave-distance-dividing module and an optical sensor module is provided. The optical storage module contains an optical storage medium. The light-switching module selects a final light source according to the type of optical storage medium and projects the light from the selected final light source outward. The wave-distance-dividing module divides the final light source from the light-switching module into equidistant light sources and projects the light onto the optical storage medium. The optical sensor module identifies the data stored within the optical storage medium according to the light reflected from the optical storage medium.

### BACKGROUND OF INVENTION

1. Field of the Invention

The present invention relates to an optical medium storage reading device. More particularly, the present invention relates to an optical medium storage reading device suitable for reading different types of optical storage medium having equidistant data tracks.

2. Description of the Related Art

Nowadays, optical storage medium has almost completely replaced the conventional magnetic tapes or magnetic disks as the principal multimedia storage device. Optical storage medium not only has a few times more storage capacity than magnetic tapes or magnetic disk for the same volume, but also has a higher audio/video storage quality. At present, devices that deploys an optical storage medium includes compact disc (CD), video compact disc (VCD), digital video disc (DVD), re-writable compact disc (CD-RW) and so on.

FIG. 1 is a schematic diagram of a conventional optical storage medium reading device. As shown in FIG. 1, an optical storage medium reading device comprises a light source 110, a first alignment module 120, a second alignment module 130, an optical sensor module 140 and an optical storage medium 150. The first alignment module 120 further comprises a first lens 123, a second lens 125 and a beam splitter 121. The light source 110 emits a beam of divergent light rays 111. The divergent light rays 111 travels to the first lens 123 to form a parallel beam 112. The parallel beam 112 passes through the beam splitter 121 and incident upon the second lens 125. The second lens 125 focuses the parallel beam 112 to form a light spot 112 projecting onto one of data tracks on the optical storage medium 150. The optical storage medium 150 reflects the incoming light back towards the second lens 125 and produces a beam of parallel light 114 that projects onto the beam splitter 121. The beam splitter 121 reflects the parallel beam 114 to form a parallel beam 115 that directs towards the second alignment module 130. The second alignment module 130 focuses the parallel beam 115 onto the optical sensor module 140 so that data from the optical storage medium can be read.

In the conventional technique, the light source is a point light source so that the light wave emitted from the light source cannot position accurately on the data tracks of different optical storage medium (such as CD, DVD and so on). Furthermore, with a point light source, data can only be read in a single point reading mode. Hence, the only way to increase data accessing speed of a large capacity storage device is to increase the rotating speed of the optical disc. Yet, increasing the speed rotation of an optical disc is not a solution because of the many problems that are associated with reading from a fast spinning disc.

### SUMMARY OF INVENTION

Accordingly, one objective of the present invention is to provide an optical storage medium reading device capable of tracking data on an optical storage medium accurately so that data on the optical storage medium can be read out faster.

To achieve these and other advantages and in accordance with the purpose of the invention, as embodied and broadly described herein, the invention provides an optical storage medium reading device. The optical storage medium reading device comprises an optical storage module, a light-switching module, a wave-distance-dividing module and an optical sensor module. The optical storage module houses an optical medium. The light-switching module chooses one of several final light sources to project a beam of light outward in accordance with the kind of optical storage medium. The wave-distance-dividing module divides the final light source projected from the light-switching module into an equidistant light source before projecting to the optical storage medium. The optical sensor module identifies the data on the optical storage medium according to the light reflected from the optical storage medium.

Accordingly, the light-switching module can produce different types of final light source. In this embodiment, the wavelength of the final light source can have a wavelength of 650 nm or 780 nm.

In another embodiment of this invention, the final light sources after a division by the wave-distance-dividing module can have a wave separation of 0.74 μm or 1.6 μm.

In one embodiment of this invention, the optical storage medium reading device further includes an alignment module for receiving the light coming from the light-switching module and projecting the light to the optical storage medium. Furthermore, the optical storage medium reading device also has another alignment module for receiving the light reflected from the optical storage medium and projecting the light to the optical sensor module.

The aforementioned alignment modules further includes a plurality of spherical lenses for focusing incoming light to various sensor cells on the optical sensor module.

In one embodiment of this invention, the optical sensor module further comprises a plurality of concave lenses for magnifying the images falling on the optical sensor module before projecting onto the optical sensor cells.

In another embodiment of this invention, the optical sensor module of the optical storage medium reading device further comprises a micro-adjusting module for shifting the location of the optical sensor module so that the light reflected from the optical storage medium is accurately focused onto the optical sensor module.

In brief, this invention provides an optical storage medium reading device having a light-switching module for changing the light source to a different wavelength or a different wave distance. Hence, data on the equidistant tracks of an optical storage medium can be fully and flexibly utilized. Furthermore, if the final light rays emitted from the light-switching module are linear, a multiple of data tracks on the optical storage medium can be read out simultaneously. Ultimately, the data read-out rate increases exponentially.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional optical storage medium reading device.

FIG. 2 is a block diagram showing the component layout of an optical storage medium reading device according to a first preferred embodiment of this invention.

FIG. 3 is a block diagram showing the component layout of an optical storage medium reading device according to a second preferred embodiment of this invention.

FIG. 4 is a side view of an optical storage medium reading device according to one preferred embodiment of this invention.

FIG. 5A is a front view of the optical storage medium reading device shown in FIG. 4.

FIG. 5B is a front view of the optical storage medium reading device shown in FIG. 4 but having a different optical sensor alignment module.

FIG. 6A is a top view of the optical storage medium reading device as shown in FIG. 4.

FIG. 6B is a top view of the optical storage medium reading device as shown in FIG. 5B.

FIG. 7 is a block diagram showing the component layout of an optical storage medium reading device according to a third preferred embodiment of this invention.

FIG. 8 is a side view of an optical storage medium reading device according to another embodiment of this invention.

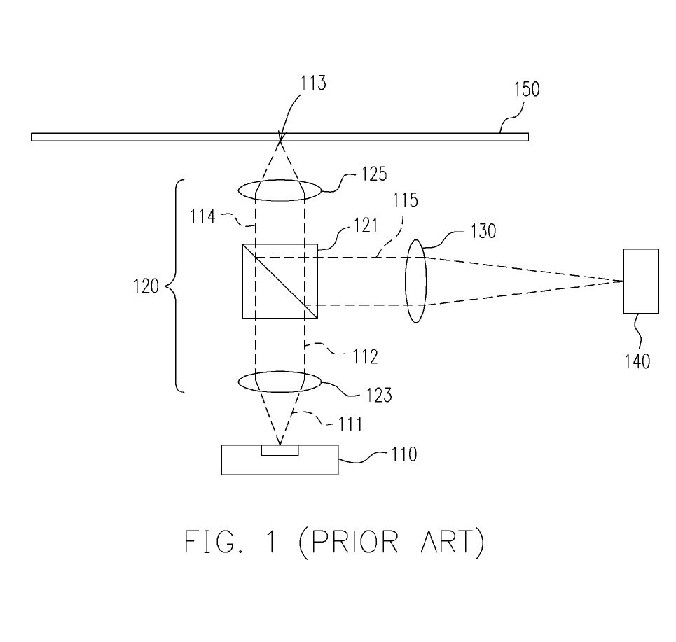

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

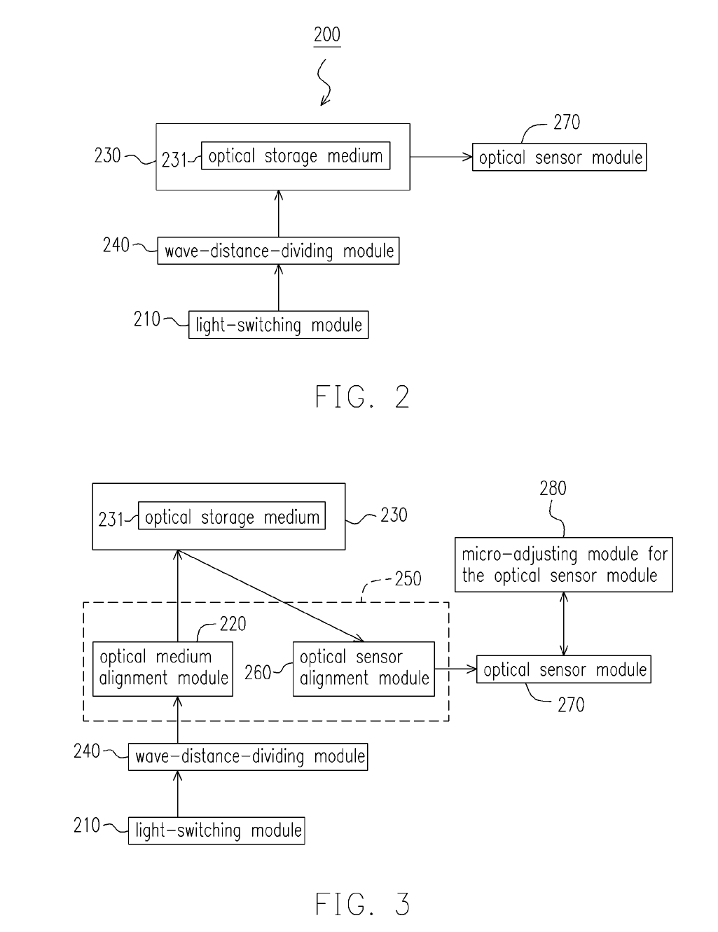

FIG. 2 is a block diagram showing the component layout of an optical storage medium reading device according to a first preferred embodiment of this invention. As shown in FIG. 2, the optical storage medium reading device 200 comprises a light-switching module 210, an optical storage module 230, a wave-distance-dividing module 240, an optical storage medium 231 and an optical sensor module 270. The light-switching module 210 selects the most appropriate final light source among several final light sources according to the optical storage medium 231 within the optical storage module 230 and projects the selected final light source onto the wave-distance-dividing module 240. The wave-distance-dividing module 240 divides the final light source into an equidistant light source before projecting onto the optical storage medium 231 inside the optical storage module 230. The optical storage medium 231 reflects the light to the optical sensor module 270 so that the optical sensor module 270 can identify the data on the optical storage medium 231.

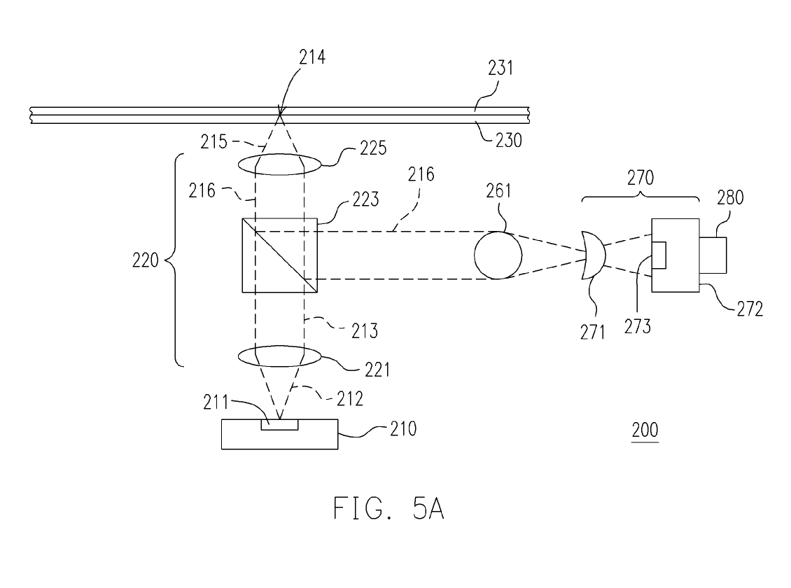

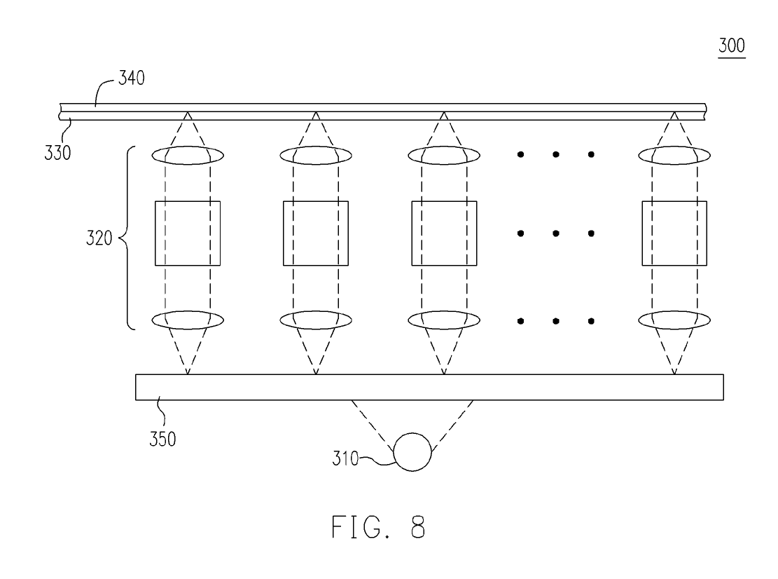

FIG. 4 is a side view of an optical storage medium reading device according to one preferred embodiment of this invention. FIG. 8 is a side view of an optical storage medium reading device according to another embodiment of this invention. In FIG. 4, the light-switching module 210 has a plurality of point light sources 211 that can be turned on or off as desired. Furthermore, the light-switching module 210 may activate the light sources 211 to emit light with a wavelength of either 650 nm or 780 nm. In FIG. 8, a wave-distance-dividing module 350 is introduced. The light-switching module 310 projects a beam of light having a final wavelength onto the wave-distance-dividing module 350 so that the light source is divided into a plurality of equidistant light sources with a wave distance of either 0.74 μm or 1. μm.

In the aforementioned embodiment, light sources emitting light with a wavelength of 650 nm and 780 nm are chosen to explain the switching capacity of the light-switching module and a wave distance of 0.74 μm and 1.6 μm are chosen to illustrate the function of the wave-distance-dividing module. However, this should by no means limit the wavelength and the wave distance as such. Anyone familiar with the technology may notice that the wavelengths and wave distances can be selected to fit any particular applications.

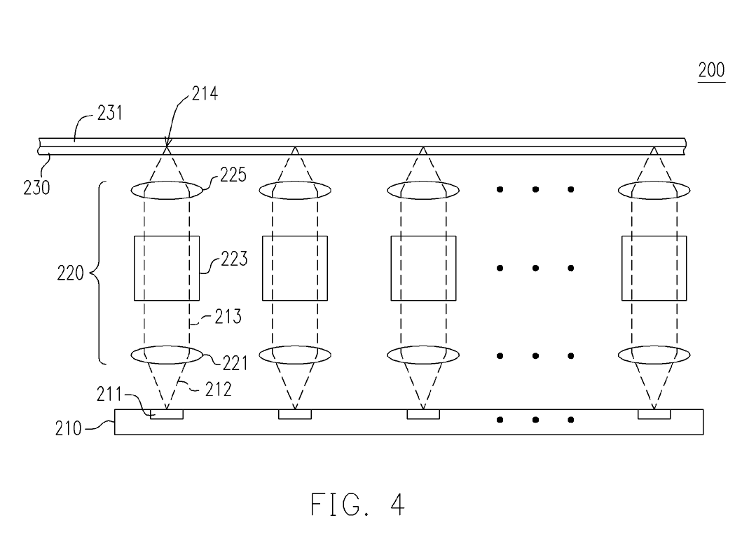

FIG. 3 is a block diagram showing the component layout of an optical storage medium reading device according to a second preferred embodiment of this invention. To ensure the light emitted from the light-switching module 210 can accurately project onto the optical storage medium 231 and the light reflected from the optical storage medium 231 is able to project accurately onto the optical sensor module 270, the optical storage medium reading device 200 provides an alignment module 250. In addition, the optical storage medium reading device 200 in this embodiment also provides a micro-adjusting module 280 for shifting the position of the optical sensor module 270 so that the light reflected from the optical storage medium 231 can focus precisely on the optical sensor module 270.

The alignment module 250 in FIG. 3 can be further divided into an optical storage medium alignment module 220 and an optical sensor alignment module 260. The optical storage medium alignment module 220 receives the light emitted from the light source 210 and projects the light accurately onto the optical storage medium 231. The optical sensor alignment module 260 receives the light reflected from the optical storage medium 231 and projects the light accurately onto the optical sensor module 270. Although the optical storage medium alignment module 220 and the optical sensor alignment module 260 are shown as separate devices in this embodiment, the two can be implemented as a single unit such as a beam splitter.

As shown in FIG. 4, the light-switching module 210 further comprises a plurality of point light sources 211 and the optical storage medium alignment module 220 comprises an optical system having a first lens 221, a beam splitter 223 and a second lens 225, for example. It is to be noted that not all of the components inside the optical storage medium reading device 200 are shown in the figure. The optical storage medium reading device 200 should further include an optical sensor module for receiving light reflected from the optical storage medium. In general, the light-switching module 210 changes the wavelength of the light source 211, for example, from 650 nm to 780 nm or vice versa, according to the type of optical storage medium 231. Light 212 from the light source 211 is calibrated into a parallel beam 213 after passing through the first lens 221. The parallel beam 213 passes through the beam splitter before entering the second lens 225. The second lens 225 focuses the parallel beam 213 to form a light spot 214 on one of the data tracks of the optical storage medium 231.

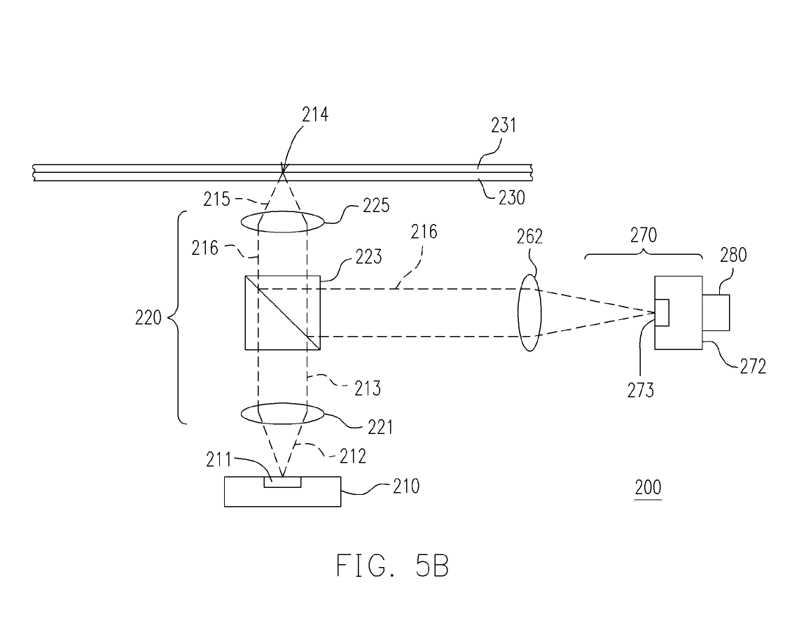

FIG. 5A is a front view of the optical storage medium reading device shown in FIG. 4. In FIG. 5A, an optical sensor alignment module with a spherical lens 261, the optical sensor module 270 and the micro-adjusting module 280 can be seen besides the components in FIG. 4. After the second lens 225 has focused the parallel beam 213 to form a light spot 214 on the optical storage medium 231, a portion of the light reflects from the optical storage medium 231 back to the second lens 225 and produces another parallel beam 216. The beam splitter 223 deflects the parallel beam 216 to the spherical lens 261. The spherical lens 261 collimates the reflected light to the optical sensor module 270 so that the optical sensor module 270 can read off the data encoded in the optical storage medium 231. The micro-adjusting module 280 is deployed to adjust the location of the optical sensor module 270 so that the light wave 215 reflected from the optical storage medium 231 can focus accurately on the optical sensor module 270.

FIG. 5B is a front view of the optical storage medium reading device shown in FIG. 4 but having a different optical sensor alignment module. In this embodiment, the optical sensor alignment module of the optical storage medium reading device 200 has a convex lens 262 instead of a spherical lens.

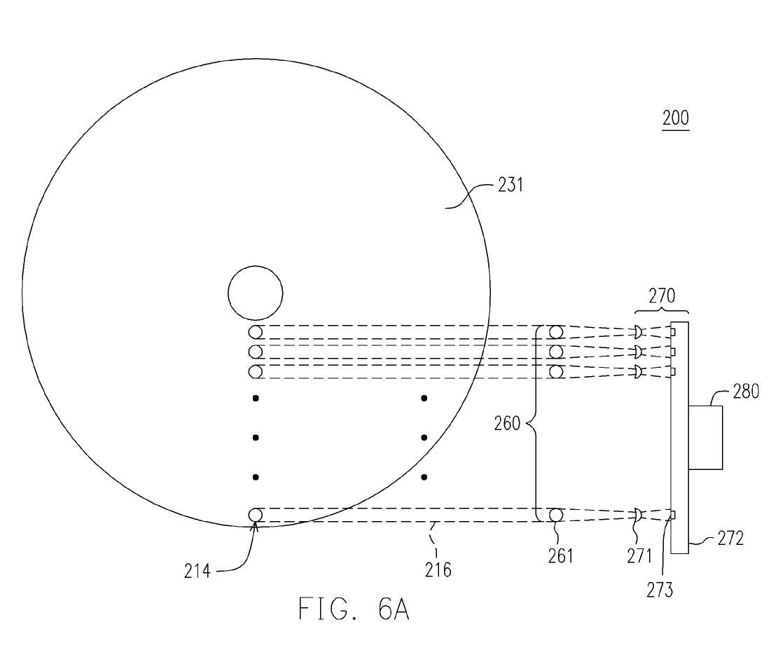

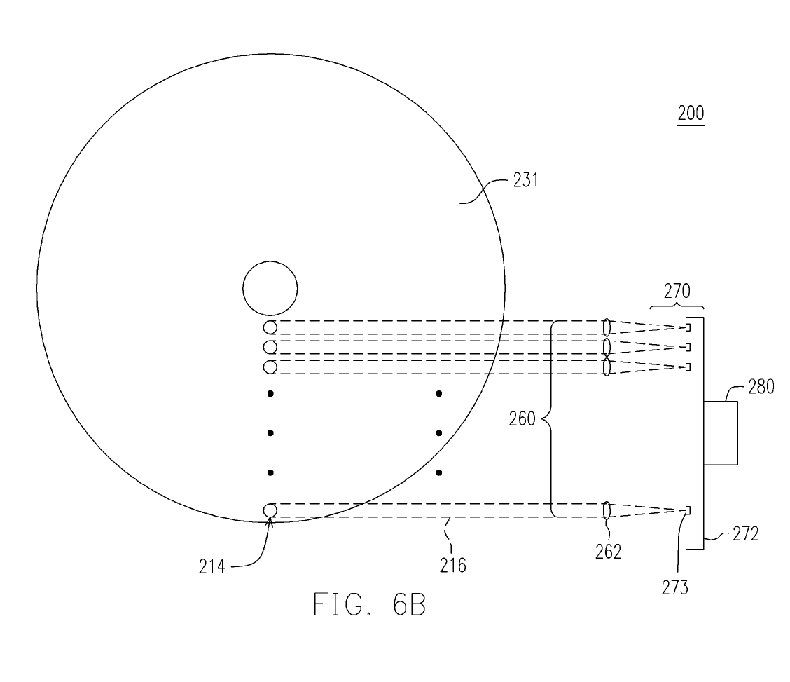

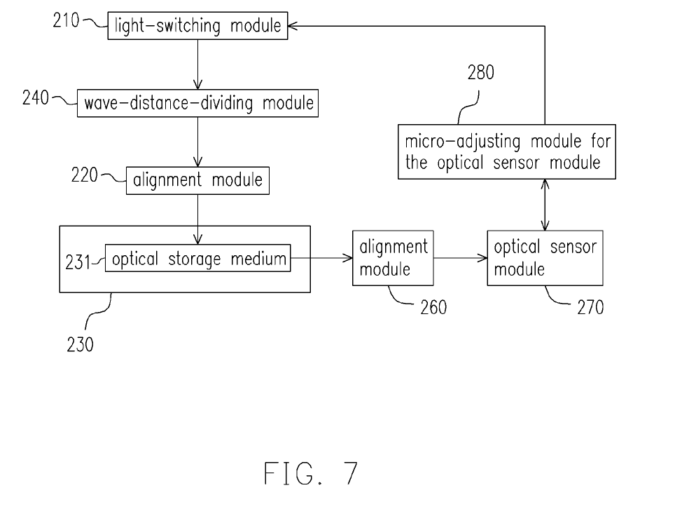

FIG. 6A is a top view of the optical storage medium reading device as shown in FIG. 4. As shown in FIG. 6A, the optical sensor alignment modules 260 mainly comprises of a plurality of focusing lens such as spherical lenses 261 and the optical sensor module 270 mainly comprises of an optical sensor cell array 272. The optical sensor cell array 272 has a plurality of optical sensor cells 273 therein. When parallel beams 216 of reflected light enter various spherical lenses 216, the parallel beams 216 are focused on various optical sensor cells 273. Similarly, FIG. 6B is a top view of the optical storage medium reading device when convex lenses 262 as shown in FIG. 5B instead of spherical lenses are used.

Although the aforementioned embodiments permit a proper focusing of all reflected light onto the optical sensor cells, the design is by no means limited as such. In fact, any other modifications that permit the focusing reflected light onto various optical sensor cells are within the scope of this invention.

As shown in FIGS. 5A and 6A, the spherical lenses 261 has a capacity to focus the parallel beams 216 to tiny spots. When the light spots are too tiny, alignment with various optical sensor cells 273 is difficult. To facilitate the projection of parallel beams 216 onto the optical sensor cells 273, a lens system that includes an additional concave lens 271 is often incorporated to the optical sensor module. When the parallel beams 216 reach the spherical lenses, the spherical lenses focus the light onto the concave lens 271 so that the concave lens 271 can magnify the incoming light a little before projecting the light onto the optical sensor cells 273.

FIG. 7 is a block diagram showing the component layout of an optical storage medium reading device according to a third preferred embodiment of this invention. In this embodiment, the micro-adjusting module 280 is used to shift the optical sensor module 270. If the process of reading data out of the optical storage medium 231 is inefficient, the micro-adjusting module 280 will submit an optical sensor signal to the light-switching module 210. Accordingly, the light-switching module 210 may change the light source type and/or the light source location so that the data read-out rate of the optical sensor module 270 is improved.

FIG. 8 is a side view of an optical storage medium reading device according to another embodiment of this invention. The light-switching module 310 and the wave-distance-dividing module 350 of the optical storage medium reading device 300 have been explained in a previous discussion. The wave-distance-dividing module 350 projects the equidistant slight sources onto various data tracks on the optical storage medium 340 inside the optical storage module 330. Since the operating principals are the same as before, detail description is omitted.

Accordingly, this invention provides a light-switching module to change the wavelength of light sources and/or a wave-distance-dividing module to change wave distance so that the final wavelength light source selected by the light-switching module can provide the required number of equidistant light sources. Hence, this invention can be applied to all optical storage media with equidistant data tracks. Furthermore, under some favorite conditions, this invention also permits the replacement of point light sources with linear light sources so that data on different data tracks can be read from the optical storage medium at any one time. Ultimately, data read-out rate can be increased in multiple increments.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An optical storage medium reading device, comprising:
an optical storage module, having an optical storage medium therein;
a light-switching module, for selecting a final light source according to the optical storage medium and projecting the light form the final light source outward;
a wave-distance-dividing module, for dividing the selected final light source into equidistant light sources and projecting the light sources onto the optical storage medium; and
an optical sensor module, for identifying data on the optical storage medium according to the light wave reflected from the optical storage medium inside the optical storage module.

2. The device of claim 1, wherein the wavelength of one of the final light sources is 650 nm.

3. The device of claim 1, wherein the wavelength of one of the final light sources is 780 nm.

4. The device of claim 1, wherein the distance of separation of the light sources after the final light source is divided by the wave-distance-diving module is 0.74 μm.

5. The device of claim 1, wherein the distance of separation of the light sources after the final light source is divided by the wave-distance-diving module is 1.6 μm.

6. The device of claim 1, wherein the device further comprises an alignment module for receiving light from the wave-distance-dividing module and projecting the light onto the optical storage medium.

7. The device of claim 1, wherein the device further comprises an alignment module for receiving light reflected from the optical storage medium and projecting the reflected light onto the optical sensor module.

8. The device of claim 7, wherein the alignment module further comprises a plurality of spherical lenses for focusing the reflected light onto a plurality of optical sensor cells on the optical sensor module.

9. The device of claim 1, wherein the device further comprises a micro-adjusting module for shifting the optical sensor module so that light reflected from the optical storage medium can focus accurately onto the optical sensor cells of the optical sensor module.

10. The device of claim 1, wherein the optical sensor module further comprises a plurality of concave lenses for magnifying light falling on the optical sensor module to an image that targets various optical sensor cells on the optical sensor module is produced.

11. The device of claim 1, wherein the light-switching module adjusts according to a type of final light source selected and the location of the light sources according to the signal from the micro-adjusting module.
